(19) United States
(12) Patent Application Publication
(10) Pub. No.: US 2025/0298727 A1
(43) Pub. Date: Sep. 25, 2025

(54) SYSTEM AND METHOD FOR TRANSLATING A TEST SCRIPT

(71) Applicant: The Toronto-Dominion Bank, Toronto (CA)

(72) Inventors: Yongze DU, Oakville (CA); Babatunde Adeyinka KASSIM, Mississauga (CA); Nandhini SHANKAR, Mississauga (CA); Aayush KATHURIA, Brampton (CA)

(73) Assignee: The Toronto-Dominion Bank, Toronto (CA)

(21) Appl. No.: 18/615,205

(22) Filed: Mar. 25, 2024

(51) Int. Cl. G06F 11/36

(52) U.S. Cl. CPC G06F 11/368; G06F 11/3684; G06F 11/3688; G06F 11/3696

(57) ABSTRACT

A computer server system comprises at least one processor; a communications module coupled to the at least one processor; and a memory coupled to the at least one processor and storing processor-executable instructions which, when executed by the at least one processor, configure the at least one processor to define a context model that includes at least one command for performing a specific action; map the at least one command to at least one corresponding command of one or more automation testing tools; obtain a test script and an indication of selection of a first automation testing tool, the test script generated within the context model and including the at least one command; and translate the test script into a first format compliant with the first automation testing tool based at least on the mapping.

### TECHNICAL FIELD

The present application relates to systems and methods for translating a test script.

### BACKGROUND

Software automation testing involves using tools and frameworks to automate the execution of test cases, thereby reducing manual effort and increasing efficiency in software testing processes.

Oftentimes, software automation testing relies on multiple automation testing tools and as such programmers are required to learn and have functional knowledge of each automation testing tool.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level schematic diagram of an example computing device;

FIG. 3 shows a simplified organization of software components stored in a memory of the example computing device of FIG. 2;

FIG. 4 is a flowchart showing operations performed by a server computer system in translating a test script into a first format compliant with a first automation testing tool according to an example embodiment;

FIG. 5 is an example context model hierarchy according to an example embodiment; and

FIG. 6 is a flowchart showing operations performed by a server computer system in translating a test script into a second format compliant with a second automation testing tool according to an example embodiment.

Like reference numerals are used in the drawings to denote like elements and features.

### DETAILED DESCRIPTION OF VARIOUS EMBODIMENTS

Accordingly, in one aspect there is provided a computer server system comprising at least one processor; a communications module coupled to the at least one processor; and a memory coupled to the at least one processor and storing processor-executable instructions which, when executed by the at least one processor, configure the at least one processor to define a context model that includes at least one command for performing a specific action; map the at least one command to at least one corresponding command of one or more automation testing tools; obtain a test script and an indication of selection of a first automation testing tool, the test script generated within the context model and including the at least one command; and translate the test script into a first format compliant with the first automation testing tool based at least on the mapping.

In one or more embodiments, the instructions, when executed by the at least one processor, further configure the at least one processor to engage the first automation testing tool to execute the translated test script.

In one or more embodiments, the instructions, when executed by the at least one processor, further configure the at least one processor to obtain an indication of selection of a second automation testing tool; and translate the test script into a second format compliant with the second automation testing tool based at least on the mapping.

In one or more embodiments, the defined context model includes a plurality of commands for performing a plurality of actions.

In one or more embodiments, when translating the test script into the first format compliant with the first automation testing tool, the instructions, when executed by the at least one processor, further configure the at least one processor to generate at least one import statement for importing at least one module or library associated with the first automation testing tool.

In one or more embodiments, the one or more automation testing tools include at least one of a browser automation testing tool, a desktop automation testing tool, a mobile automation testing tool, or an application programming interface automation testing tool.

In one or more embodiments, the at least one command for performing the specific action is defined as a generic command within the context model.

In one or more embodiments, the instructions, when executed by the at least one processor, further configure the at least one processor to send, via the communications module and to a computing device, a signal causing the computing device to display a graphical user interface for generating the test script within the context model.

In one or more embodiments, the graphical user interface includes at least one interface element for providing the indication of the selection of the first automation testing tool.

In one or more embodiments, the indication of the selection of the first automation tool is included in the test script.

According to another aspect there is provided a computer-implemented method comprising defining a context model that includes at least one command for performing a specific action; mapping the at least one command to at least one corresponding command of one or more automation testing tools; obtaining a test script and an indication of selection of a first automation testing tool, the test script generated within the context model and including the at least one command; and translating the test script into a first format compliant with the first automation testing tool based at least on the mapping.

In one or more embodiments, the method further comprises engaging the first automation testing tool to execute the translated test script.

In one or more embodiments, the method further comprises obtaining an indication of selection of a second automation testing tool; and translating the test script into a second format compliant with the second automation testing tool based at least on the mapping.

In one or more embodiments, the defined context model includes a plurality of commands for performing a plurality of actions.

In one or more embodiments, translating the test script into the first format compliant with the first automation testing tool includes generating at least one import statement for importing at least one module or library associated with the first automation testing tool.

In one or more embodiments, the one or more automation testing tools include at least one of a browser automation testing tool, a desktop automation testing tool, a mobile automation testing tool, or an application programming interface automation testing tool.

In one or more embodiments, the at least one command for performing the specific action is defined as a generic command within the context model.

In one or more embodiments, the method further comprises sending, to a computing device, a signal causing the computing device to display a graphical user interface for generating the test script within the context model.

In one or more embodiments, the graphical user interface includes at least one interface element for providing the indication of the selection of the first automation testing tool.

According to another aspect there is provided a non-transitory computer readable medium having stored thereon processor-executable instructions which, when executed by at least one processor, configure the at least one processor to define a context model that includes at least one command for performing a specific action; map the at least one command to at least one corresponding command of one or more automation testing tools; obtain a test script and an indication of selection of a first automation testing tool, the test script generated within the context model and including the at least one command; and translate the test script into a first format compliant with the first automation testing tool based at least on the mapping.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

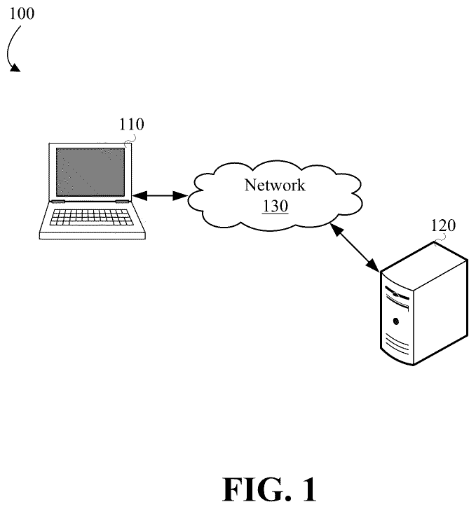

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The computing device 110 may be a laptop computer as shown in FIG. 1. However, the computing device 110 may be a computing device of another type such as for example a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

As will be described in more detail below, the server computer system 120 may be configured to define a context model. The context model may be used to generate generic automation testing code in the form of a test script and may translate the test script into a format compliant with one or more automation testing tools.

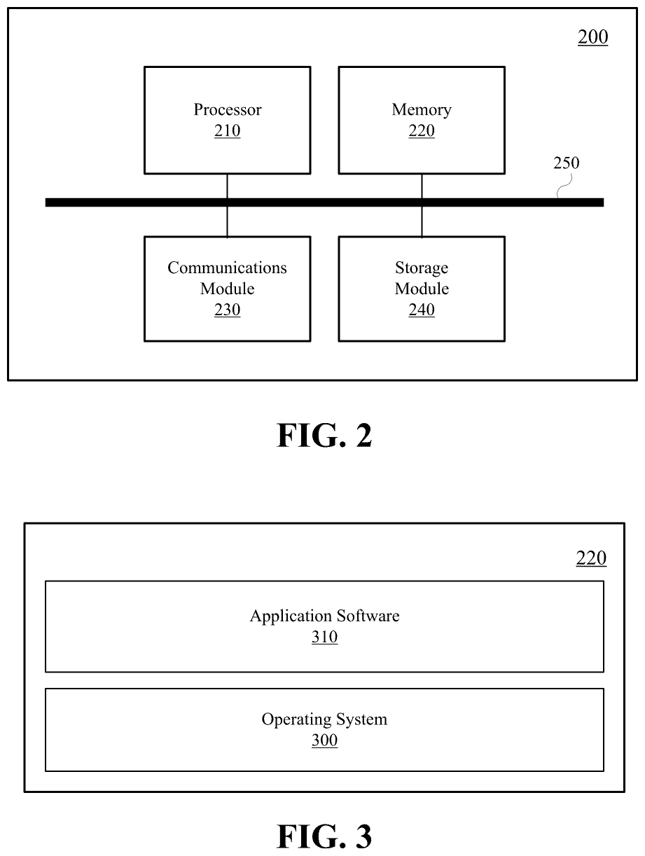

FIG. 2 is a high-level schematic diagram of a computer system 200. The computer system 200 may be any one of the computing device 110 and/or the server computer system 120.

The computer system 200 includes a variety of modules. For example, as illustrated, the computer system 200 may include a processor 210, a memory 220, a communications module 230, and/or a storage module 240. Further, while not illustrated in FIG. 2, the computer system 200 may include an I/O module. As illustrated, the foregoing example modules of the computer system 200 are in communication over a bus 250. As such, the bus 250 may be considered to couple the various modules of the computer system 200 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the computer system 200.

The communications module 230 allows the computer system 200 to communicate with other computing devices and/or various communications networks such as, for example, the network 130. For example, the communications module 230 may allow the computer system 200 to send or receive communications signals. Communications signals may be sent or received according to one or more protocols or according to one or more standards. The communications module 230 may allow the computer system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the computer system 200 to communicate using near-field communication (NFC), via Wi-Fi™, using Bluetooth™ or via some combination of one or more networks or protocols. In some embodiments, all or a portion of the communications module 230 may be integrated into a component of the computer system 200. For example, the communications module 230 may be integrated into a communications chipset.

The I/O module is an input/output module. The I/O module allows the computer system 200 to receive input from and/or to provide input to components of the computer system 200 such as, for example, various input modules and output modules. For example, the I/O module may, as shown, allow the computer system 200 to receive input from and/or provide output to a display.

The storage module 240 allows data to be stored and retrieved. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in/from a database, such as the database 140 of FIG. 1 when the computer system is operating as the server computer system 120 of FIG. 1. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the computer system 200. As illustrated, these software components include an operating system 300 and an application software 310.

The operating system 300 is software. The operating system 300 allows the application software 310 to access the processor 210 (FIG. 2), the memory 220, the communications module 230, the I/O module, and the storage module 240 of the computer system 200. The operating system 300 may be, for example, Google™ Android™, Apple™ iOS™, UNIX™, Linux™, Microsoft™ Windows™, Apple OSX™ or the like.

The application software 310 adapts the computer system 200, in combination with the operating system 300, to operate as a device for performing a specific function. For example, the application software 310 may cooperate with the operating system 300 to adapt a suitable embodiment of the example computer system 200 to operate as the computing device 110 and/or the server computer system 120.

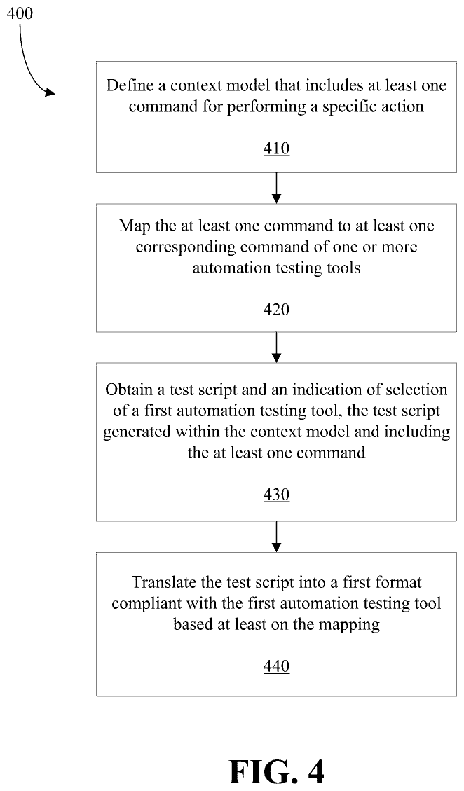

The server computer system 120 may be configured to translate test scripts. Reference is made to FIG. 4, which illustrates, in flowchart form, a method 400 for translating a test script into a first format compliant with a first automation testing tool. The method 400 may be implemented by a computing device having suitable processor-executable instructions for causing the computing device to carry out the described operations. The method 400 may be implemented, in whole or in part, by the server computer system 120.

The method 400 includes defining a context model that includes at least one command for performing a specific action (step 410).

The server computer system 120 defines a context model. In one or more embodiments, the context model represents or models a generic automation testing tool that may allocate, manage and release resources.

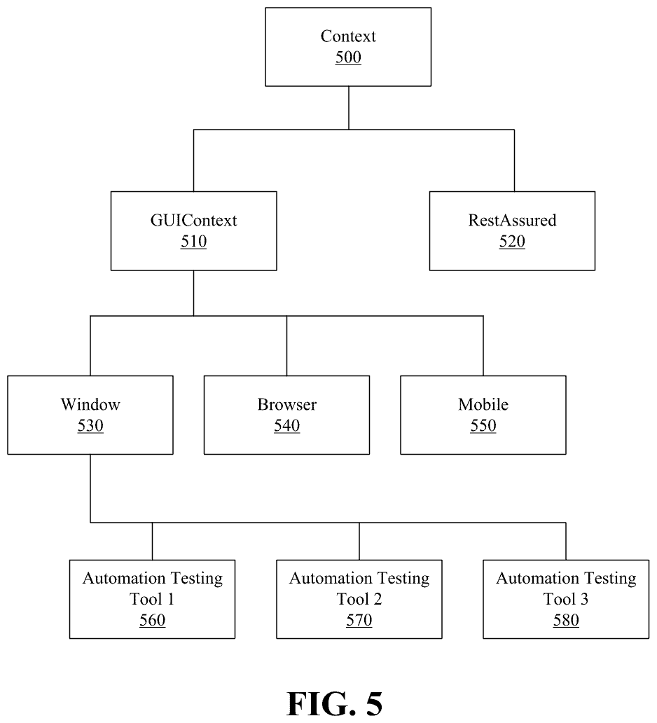

The context model may include a hierarchy based on Object Oriented Programming. An example context model hierarchy is shown in FIG. 5. As can be seen, Context 500 is defined at the first level of the hierarchy.

The second level of the hierarchy is linked to the Context 500 and includes GUIContext 510 and RestAssured 520. GUIContext 510 refers to automation testing of an application that falls within a GUI context. RestAssured 520 refers to automation testing of an application programming interface (API).

The third level of the hierarchy is linked to GUIContext 510 and includes Window 530, Browser 540, and Mobile 550. Window 530 refers to automation testing of a Windows™ application. Browser 540 refers to automation testing of a browser application. Mobile 550 refers to automation testing of a mobile application.

The fourth level of the hierarchy is linked to Window 530 and includes Automation Testing Tool 1 560, Automation Testing Tool 2 570 and Automation Testing Tool 3 580. The Automation Testing Tool 1, Automation Testing Tool 2 and Automation Testing Tool 3 are automation testing tools that may be used for automation testing of a Windows™ application.

It will be appreciated that additional levels may be included in the hierarchy. For example, one or more automation testing tools for testing a browser application may be linked to Browser 540 and one or more automation testing tools for testing a mobile application may be linked to Mobile 550.

The hierarchy shown in FIG. 5 may be used to map or link generic commands defined within Context 500 to specific commands within, for example, one or more of the automation testing tools.

The context model is defined to include at least one command for performing a specific action. The at least one command may include, for example, navigation commands, element identification commands, interaction commands, alert handling commands, window handling commands, frame handling commands, wait commands, etc. Of course, the contest model may be defined to include a plurality of commands for performing a plurality of actions.

Example navigation commands may include get, navigate to, navigate back, navigate forward, etc.

Example element identification commands may include find element, find elements, etc.

Example interaction commands may include click, send keys, clear, submit, get attribute, get text, is selected, is enabled, is displayed, get size, etc.

Example alert handling commands may include switch to alert, alert accept, alert dismiss, alert get text, etc.

Example window handling commands may include get window handle, get window handles, switch to window, etc.

Example wait commands may include implicit wait, explicit wait, etc.

The above examples are not limiting. The at least one command may include any command used during automation testing such as for example any command used during API testing, window application testing, browser application testing, mobile application testing, etc.

The at least one command for performing the specific action may be defined as a generic command within the context model. For example, each command defined within the context model may be called using a generic name that may be related to the specific action. For example, a command to perform an action that includes a mouse click may be defined within the context model as “click” or “mouse click”. As another example, a command to perform an action that includes opening a web page may be defined within the context model as get (url).

The at least one command may be stored in a library of commands. For example, a list of all commands available for automation testing may be generated and stored in a database.

The method 400 includes mapping the at least one command to at least one corresponding command of one or more automation testing tools (step 420).

The at least one command is mapped to at least one corresponding command of one or more automation testing tools. The one or more automation tools may include, for example, at least one of SeleniumBrowser™, AppiumMobile™, Winium Window™, TEWindow™, LeanFTWindow™, or AutoitWindow™.

In one or more embodiments, the mapping may be performed during a configuration process when an automation testing tool is being onboarded onto the system described herein. The mapping may include linking the at least one command to the at least one corresponding command of the one or more automation tools.

As one example, the at least one command may include a command to perform an action that includes a mouse click on a button identified as “button_id”. As such, within the context model, the at least one command may be called as “click(button_id)” or “click button_id”.

The at least one command may be mapped or linked to at least one command of the one or more automation testing tools that are known to perform the same action, which in this example is a mouse click.

For example, the at least one command “click(button_id)” may be linked or mapped to a mouse click command defined within the SeleniumBrowser™ automation testing tool. Specifically, the at least one command “click(button_id)” may be linked to the following command within SeleniumBrowser™ automation testing tool:

//Find the button element and click on it
driver.findElement(By.id(“button_id”));
button.click( )

As another example, the at least one command “click(button_id)” may be linked or mapped to a mouse click command defined within the AppiumMobile™ automation testing tool:

//Find the button element and click on it
driver.findElementByID(“button_id”);
button.click( );

As yet another example, the at least one command “click(button_id)” may be linked or mapped to a mouse click command defined within the Winium Window™ automation testing tool:

// Find the button element and click on it
driver.findElement(By.id(“button_id”)).click( );

As still yet another example, the at least one command “click(button_id)” may be linked or mapped to a mouse click command defined within the LeanFTWindow™ automation testing tool:

```
//Define the description for the button
ButtonDescription buttonDescription = new ButtonDescription.Builder( )
  .identifier(“button_id”)
  .build( );
// Find the button element within the window
Button button = window.describe(Button.class, buttonDescription);
// Click the button
button.click( );
```

As yet another example, the at least one command “click(button_id)” may be linked or mapped to a mouse click command defined within the AutoitWindow™ automation testing tool:

//Click button using its control ID
ControlClick(“WindowTitle”, “”, “button_id”)

As another example, the at least one command “click(button_id)” may be linked or mapped to a mouse click command defined within the TEWindow™ automation testing tool:

//Click the button using its control ID
ControlClick(“WindowTitle”, “”, “button_id”)

It will be appreciated that in at least some of the above examples, it may be required to identify the window that contains the button to click. As such, the at least one command may be defined in two manners such that it may accept more than one parameter as input. For example, the at least one command may be defined as “click(button_id)” for automation testing tools that do not require a window identification and may be defined as “click(button_id, window_id)” for automation testing tools that require a window identification. The two definitions may be mapped or linked to the corresponding commands of the automation testing tools based on whether or not each automation testing tool requires window identification. For example, the mouse click command defined within any automation testing tool that does not require window identification may be mapped to “click(button_id)” and the mouse click command defined within any automation testing tool that does require window identification may be mapped to “click(button_id, window_id)”.

The method 400 includes obtaining a test script and an indication of selection of a first automation testing tool, the test script generated within the context model and including the at least one command (step 430).

In one or more embodiments, the server computer system 120 may obtain the test script and the indication of selection of the first automation testing tool from the computing device 110.

To obtain the test script and the indication of selection of the first automation testing tool, the server computer system 120 may provide a graphical user interface for generating the test script within the context model. The server computer system 120 may send a signal to the computing device 110 that causes the computing device 110 to display the graphical user interface for generating the test script within the context model. The graphical user interface may enable communication between the computing device 110 and the server computer system 120.

The graphical user interface may be presented to the computing device 110 within a software application such as for example a Windows™ software application.

The graphical user interface may allow or enable an operator of the computing device 110 to generate the test script. The test script is generated to include the at least one command for performing a specific action on a particular software application or application programming interface. The test script may include a plurality of commands and may be generated to test one or more features or graphical user interfaces of the particular software application or application programming interface.

In one or more embodiments, the indication of the selection of the first automation tool may be included in the test script. For example, a first line of the test script may include a command such as “test application_name with automation_tool_name”. This may indicate that “application_name” is to be tested using the test script using the “automation_tool_name”.

In one or more embodiments, rather than providing the indication of the selection of the first automation tool in the test script, the graphical user interface may include at least one interface element for providing the indication of the selection of the first automation tool. For example, the graphical user interface may include a drop down menu that may be used to provide the indication of selection of the first automation tool. As another example, the graphical user interface may include a number of radio buttons or checkboxes that may be selected to provide the indication of selection of the first automation tool.

The method 400 includes translating the test script into a first format compliant with the first automation testing tool based at least on the mapping (step 440).

Once the test script has been obtained, the server computer system 120 performs operations to translate the test script into a first format compliant with the first automation testing tool based at least on the mapping. Translating may include compiling the test script into the first format compliant with the first automation testing tool.

In one or more embodiments, the server computer system 120 may analyze the test script to obtain or otherwise extract the at least one command for performing the specific action. The server computer system 120 also obtains the indication of selection of the first automation testing tool and this may be, for example, from the test script or from the at least one interface element for providing the indication.

The server computer system 120 translates the test script into the first format at least by mapping the at least one command to the at least one corresponding command of the first automation testing tool. The server computer system 120 continues the translation by mapping all commands to corresponding commands of the first automation testing tool. In this manner, a translated test script is generated in a format compliant with the first automation testing tool.

It will be appreciated that in one or more embodiments, when translating the test script into the first format compliant with the first automation testing tool, additional operations may be required. For example, in one or more embodiments, the server computer system 120 may generate at least one import statement for importing at least one module or library associated with the first automation testing tool.

As one example, the first automation testing tool may include the SeleniumBrowser™ automation testing tool. As such, the server computer system 120 may perform operations to generate at least one import statement required for the SeleniumBrowser™ automation testing tool. The at least one import statement may depend on the programming language to be used and/or the software application to be used. The programming language and/or the software application to be used may be included in the test script or may be set automatically by the server computer system 120.

In one example, the programming language may include Java™ and the software application to be used may include Google™ Chrome™ and as such the at least one import statement may include:
import org.openqa.selenium.WebDriver;
import org.openqa.selenium.chrome.ChromeDriver;
import org.openqa.selenium.WebElement;
import org.openqa.selenium.By;

Once the test script has been translated into the first format compliant with the first automation testing tool, the translated test script may be executed by the first automation testing tool. Specifically, the server computer system 120 may engage the first automation testing tool to execute the translate test script.

In manners described herein, the context model may be utilized to generate test scripts that include generic commands that may be easily mapped or translated into formats compliant with different automation testing tools. As such, a computer programmer is only required to learn the generic commands defined within the context model and does not need to learn the specific commands for each automation testing tool available.

The test script obtained during the step 430 of the method 400 may be easily translated into a second format compliant with a second automation testing tool.

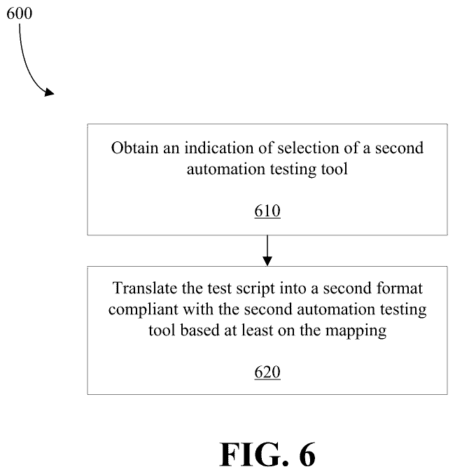

Reference is made to FIG. 6, which illustrates, in flowchart form, a method 600 for translating a test script into a second format compliant with a second automation testing tool. The method 600 may be implemented by a computing device having suitable processor-executable instructions for causing the computing device to carry out the described operations. The method 600 may be implemented, in whole or in part, by the server computer system 120.

The method 600 includes obtaining an indication of selection of a second automation testing tool (step 610).

The server computer system 120 obtains an indication of selection of a second automation testing tool. The second automation testing tool may be a different automation testing tool than the first automation testing tool. The indication may be obtained similar to that described herein with reference to step 430 of the method 400.

The method 600 includes translating the test script into a second format compliant with the second automation testing tool based at least on the mapping (step 620).

The server computer system 120 performs operations to translate the test script into a second format compliant with the second automation testing tool based at least on the mapping and this may be done in manners similar to that described herein with reference to step 440 of the method 400.

It will be appreciated that the test script may additionally or alternatively be translated into different programming languages and/or for different applications. For example, the test script may indicate that Java™ programming language is to be used. The test script may be modified to indicate that Python™ programming language is to be used and the server computer system 120 may perform operations to generate a translated test script in the indicated programming language. Of course, the generic function may be mapped to corresponding functions for software automation tools that are in different programming languages. For example, a first generic function may be mapped to a first corresponding function in a first programming language and to a second corresponding function in a second programming language for the same software automation tool. As another example, the test script may be modified to switch from a Google™ Chrome™ browser to a Mozilla™ Firefox™ browser and a translated test script may be generated accordingly.

As mentioned, in one or more embodiments, the mapping may be performed during a configuration process when an automation testing tool is being onboarded onto the system described herein. The mapping may include linking the at least one command to the at least one corresponding command of the one or more automation tools. In one or more additional or alternative embodiments, an artificial intelligence engine may be utilized to generate the mapping. For example, training data may be collected from one or more test scripts for one or more automation testing tools. The training data may be provided as input and one or more machine learning algorithms may be utilized to analyze the training data to identify one or more functions. For example, the program code may be analyzed to identify commands that are likely to be associated with performing a mouse click and this may be done from the command itself and/or from comments such as single-line comments or multi-line comments included in the test script. Single-line comments may be identified as comments following “//” and multi-line comments may be identified as comments in between “/*” and “*/”. The artificial intelligence engine may generate a list of corresponding commands for the one or more automation tools and may map commands defined within the context model thereto.

The artificial intelligence engine may additionally be utilized to generate the at least one import statement for importing at least one module or library associated with one or more of the automaton testing tools. For example, training data may be collected from one or more test scripts for one or more automation testing tools. The training data may be provided as input and one or more machine learning algorithms may be utilized to analyze the training data to identify at least one import statement required for the one or more automation testing tools.

In embodiments described herein, the context model is defined to include at least one command for performing a specific action. The at least one command may include a generic command such as for example the generic “click(button_id)” command described herein. It will be appreciated that other generic commands may be defined. For example, the context model may include a generic “with” locator command. The generic “with” locator command may be defined within the context model and may provide a centralized locator that eliminates the requirement of needing to know the actual locator required by the one or more automation testing tools. In one or more embodiments, multiple attributes may be chained to the “with” locator and may be used to uniquely identify an object. The “with” locator may be mapped to corresponding commands of the one or more automation testing tools.

In one or more embodiments, the “with” locator may be defined as:

With.<locator type>( ).<attribute 1>(value 1)[.<attribute 2>(value 2)...<attribute
n>(value n)]

where the locator type may be:

| | |
|---|---|
| java | for Java application and LeanFT |
| win | for standard windows application and LeanFT |
| te | for terminal emulator application for mainframe and |
| | LeanFT |
| autoit | for AutoIt tool and standard windows application |
| pcomm | for PComm terminal emulator integration |

and where:
   attribute is the UI object attribute name; and
   value is the expected value for the UI object attribute.

Example implementations of the “with” locator include:

/*
create a “With” locator for LeanFT tool and a terminal emulator object
whose attachedText value is “LOGONID”
*/
With.te( ).attachedText(“LOGONID”)
/ *
create a “With” locator for LeanFT tool and a Java application UI object
whose attachedText is “Details” and enabled is true
*/
With.java( ).attachedText(“Details”). enabled(true)
/*create a “With” locator for LeanFT tool and a standard windows
application UI object whose nativeClass value is “CalcFrame” and size is
212, 264*/
With.win( ).nativeClass(“CalcFrame”).size(212, 264)
/ *
create a “With” locator for AutoIt tool for a windows application UI object
whose title value is “File Upload” and class value is “#32770”
*/
With.autoit( ).title(“File Upload”). clazz(“#32770”)
/*
create a “With” locator for PComm integration whose start position is
row=12 and column=2
*/
With.pcomm( ).startPosition(12, 2)

In manners described above, a programmer is only required to learn the usage or syntax of the generic “with” locator rather than the syntax and structure of each individual automation testing tool.

The server computer system 120 described herein may additionally provide a generic data pool model that may be utilized to store and manage test data that may be used during the execution of test scripts such as those described herein. The server computer system 120 may generate or otherwise provide one or more graphical user interfaces to the computing device 110. The graphical user interfaces may include one or more elements to switch or toggle between different types of data. For example, a test case may be generated that extracts data in a first format such as for example a Microsoft™ Excel™ format. The user may wish to switch over to a second format such as for example a database format. As such, the user may select a toggle interface element to switch from the first format to the second format. The underlying data source may be changed. The user may then continue to generate the test case but not using data in the second format. As such, a user only has to work with one standardized graphical user interface and doesn't have to worry about the underlying types of data files.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

1. A computer server system comprising:
at least one processor;
a communications module coupled to the at least one processor; and
a memory coupled to the at least one processor and storing processor-executable instructions which, when executed by the at least one processor, configure the at least one processor to:
define a context model that includes at least one command for performing a specific action;
map the at least one command to at least one corresponding command of one or more automation testing tools;
obtain a test script and an indication of selection of a first automation testing tool, the test script generated within the context model and including the at least one command; and
translate the test script into a first format compliant with the first automation testing tool based at least on the mapping.

2. The computer server system of claim 1, wherein the instructions, when executed by the at least one processor, further configure the at least one processor to:
engage the first automation testing tool to execute the translated test script.

3. The computer server system of claim 1, wherein the instructions, when executed by the at least one processor, further configure the at least one processor to:
obtain an indication of selection of a second automation testing tool; and
translate the test script into a second format compliant with the second automation testing tool based at least on the mapping.

4. The computer server system of claim 1, wherein the defined context model includes a plurality of commands for performing a plurality of actions.

5. The computer server system of claim 1, wherein when translating the test script into the first format compliant with the first automation testing tool, the instructions, when executed by the at least one processor, further configure the at least one processor to:
generate at least one import statement for importing at least one module or library associated with the first automation testing tool.

6. The computer server system of claim 1, wherein the one or more automation testing tools include at least one of a browser automation testing tool, a desktop automation testing tool, a mobile automation testing tool, or an application programming interface automation testing tool.

7. The computer server system of claim 1, wherein the at least one command for performing the specific action is defined as a generic command within the context model.

8. The computer server system of claim 1, wherein the instructions, when executed by the at least one processor, further configure the at least one processor to:
send, via the communications module and to a computing device, a signal causing the computing device to display a graphical user interface for generating the test script within the context model.

9. The computer server system of claim 8, wherein the graphical user interface includes at least one interface element for providing the indication of the selection of the first automation testing tool.

10. The computer server system of claim 1, wherein the indication of the selection of the first automation tool is included in the test script.

11. A method comprising:
defining a context model that includes at least one command for performing a specific action;
mapping the at least one command to at least one corresponding command of one or more automation testing tools;
obtaining a test script and an indication of selection of a first automation testing tool, the test script generated within the context model and including the at least one command; and
translating the test script into a first format compliant with the first automation testing tool based at least on the mapping.

12. The method of claim 11, further comprising:
engaging the first automation testing tool to execute the translated test script.

13. The method of claim 11, further comprising:
obtaining an indication of selection of a second automation testing tool; and
translating the test script into a second format compliant with the second automation testing tool based at least on the mapping.

14. The method of claim 11, wherein the defined context model includes a plurality of commands for performing a plurality of actions.

15. The method of claim 11, wherein translating the test script into the first format compliant with the first automation testing tool includes generating at least one import statement for importing at least one module or library associated with the first automation testing tool.

16. The method of claim 11, wherein the one or more automation testing tools include at least one of a browser automation testing tool, a desktop automation testing tool, a mobile automation testing tool, or an application programming interface automation testing tool.

17. The method of claim 11, wherein the at least one command for performing the specific action is defined as a generic command within the context model.

18. The method of claim 11, further comprising:
sending, to a computing device, a signal causing the computing device to display a graphical user interface for generating the test script within the context model.

19. (canceled)

20. A non-transitory computer readable medium having stored thereon processor-executable instructions which, when executed by at least one processor, configure the at least one processor to:
define a context model that includes at least one command for performing a specific action;
map the at least one command to at least one corresponding command of one or more automation testing tools;
obtain a test script and an indication of selection of a first automation testing tool, the test script generated within the context model and including the at least one command; and
translate the test script into a first format compliant with the first automation testing tool based at least on the mapping.

21. The computer server system of claim 1, wherein the instructions, when executed by the at least one processor, further configure the at least one processor to:
generate the at least one corresponding command of the one or more automation testing tools using a trained artificial intelligence engine.
